(19) United States
(12) Patent Application Publication
(10) Pub. No.: US 2017/0325467 A1
(43) Pub. Date: Nov. 16, 2017

(54) Composition and Methods for Making Nutritional Snack Wafers

(71) Applicant: Tia N. BAGAN, Lake Forest, IL (US)

(72) Inventor: Tia N. BAGAN, Lake Forest, IL (US)

(73) Assignee: Nutraphagia, LLC, Portland, OR (US)

(21) Appl. No.: 15/478,921

(22) Filed: Apr. 4, 2017

Related U.S. Application Data
(60) Provisional application No. 62/336,403, filed on May 13, 2016.

(51) Int. Cl. A21D 13/50; A23L 33/00; A21D 13/40; A21D 13/20

(52) U.S. Cl. CPC A21D 13/50; A21D 13/20; A23L 33/40; A21D 13/40; A23V 2002/00

(57) ABSTRACT

A snack food that is easier for a dysphagia sufferer to consume may be made from a crisp, structural core that is highly soluble, enrobed in a calorie-dense coating such as chocolate, where the coating helps protect the core from moisture. When the snack food is bitten, the eater's saliva causes the core to disintegrate rapidly, leaving the coating without support and susceptible to rapid reduction to an easy-to-swallow paste.

This U.S. Utility patent application claims priority to U.S. Provisional Patent Application No. 62/336,403 filed 13 May 2016.

### FIELD

In general, the present inventive subject matter relates to a method for making nutritional snack wafers, and specifically for providing a high calorie nutritional oral supplement for dysphagia management.

### BACKGROUND

### The Condition of Dysphagia

Dysphagia, or difficulty swallowing, is a disorder that may be caused by stroke, neurological disease, dementia, or various clinical disorders which places the person at risk for aspiration pneumonia, dehydration, malnutrition and death.

Swallowing disorders can affect all age groups, from infant to geriatric. The condition may present acutely or develop gradually over time as a result of changes in anatomy and/or physiology.

Signs of dysphagia may include inability to recognize food, difficulty placing food in the oral cavity, inability to manage food and/or saliva in the mouth, coughing before/during/after swallowing or meals, frequent pneumonia, weight loss, and change in vocal quality.

Symptoms of dysphagia include having pain while swallowing (odynophagia); being unable to swallow; having the sensation of food getting stuck in your throat or chest (globus sensation) drooling; being hoarse; bringing food back up (regurgitation); having to cut food into smaller pieces or avoiding certain foods because of trouble swallowing. It may also include xerostomia (dry mouth), frequent reflux (food or stomach backing up into the throat) and phagophobia (fear of swallowing). Certified Speech Language Pathologists often recognize and refer individuals for dysphagia.

The act of deglutition is broken into four phases. The Oral preparatory phase occurs when food is manipulated in the mouth and masticated when necessary. This reduces the bolus to make it ready to swallow. The Oral phase of the swallow occurs when the tongue propels the bolus/food posteriorly towards the posterior pharyngeal wall. The Pharyngeal phase is involuntary and begins when the pharyngeal swallow is triggered and the bolus/food moves through the pharynx. The Esophageal phase begins when the bolus/food passes through the cricopharyngeaus, and peristalsis carries the bolus/food to the stomach.

There are a number of clinical and imaging techniques that can be used to evaluate the anatomy and physiology of the swallow. A patient may be evaluated at the bedside, with use of a Fiber optic Endoscopic Evaluation of Swallowing (FEES) or a Video fluoroscopic Swallowing Evaluation (VFSS) also referred to as a Modified Barium Swallow (MBS).

Evaluation may reveal without limitation: reduced lip closure, reduced tongue coordination, reduced lingual range of motion, reduced labial tone, reduced buccal tone, reduced lingual strength, apraxia of the swallow, tongue thrusting, reduced mandibular strength/ROM/coordination, reduce vela-pharyngeal contact, delayed oral transit time, delayed pharyngeal transit time, reduced hyolaryngeal elevation and reduced pharyngeal peristalsis.

Symptoms determined clinically or radiographically notify the clinician if the patient's swallow is disordered and the nature of the dysfunction. The clinician also uses this information to provide a diagnosis, complete recommendations for the consistency of the diet or modifications in the diet and plan treatment.

One way to improve the treatment of dysphagia is to modify the foods offered to the patient. Modifying the consistency and structure of foods and liquids aids in the management of dysphagia.

### Statistics of Dysphagia-Suffering Populations

As many as 15 million Americans are impacted with Dysphagia, with approximately one million people receiving a new diagnosis of Dysphagia every year. Each year, according to the Agency for Health Care Policy and Research, over 60,000 Americans pass away from complications associated with dysphagia and aspiration pneumonia (which is caused by food or liquids going into the lungs). One in 17 people will develop some form of dysphagia in their lifetime, including 50-75% of stroke patients and 60-70% of patients with a diagnosis of head and neck cancer. Dysphagia can be seen in up to 90% of patients who are diagnosed with a neurological disease such as Parkinson's disease and Alzheimer's disease. Some studies suggest that up to 75% of Nursing Home patients experience some degree of dysphagia. (2005 Encore Medical LP 4599A0505)

The majority of patients (87.5%) evaluated and/or treated by a Speech Language Pathologist have a diagnosis of dysphagia (ASHA. (2003). Table 1 shows the National Outcomes Measurement System (NOMS) from the Adult Speech-Language Pathology User's Guide.

TABLE 1

| S.N. | Primary Medical Diagnosis | Percentage |
|---|---|---|
| 1. | Cerebrovascular Disease | 25.3% |
| 2. | Respiratory Diseases | 22.4% |
| 3. | Hemorrhage/Injury | 4.3% |
| 4. | Head Injury | 3.1% |
| 5. | CNS Diseases | 1.9% |
| 6. | Other Neoplasm | 1.9% |
| 7. | Encephalopathy | 1.3% |
| 8. | Occlusion/TIA | 1.2% |
| 9. | Mental Disorders | 1.1% |
| 10. | Anoxia | 0.5% |
| 11. | Neoplasm Larynx | 0.3% |
| 12. | Neoplasm Lip/Pharynx | 0.2% |
| 13. | All Others | 36.5% |

| | |
|---|---|
| TOTAL | 100% |

### Measuring Dysphagia

The American Speech and Hearing Associations (ASHA) and National Outcomes Measurement System (NOMS) are voluntary data collection system developed to illustrate the value of speech-language pathology services provided to adults and children with communication and swallowing disorders.

The key to NOMS is the use of ASHA's Functional Communication Measures (FCMs). FCMs are a series of disorder-specific, seven-point rating scales designed to describe the change in an individual's functional communication and/or swallowing ability over time.

Based on an individual's treatment plan/IEP, FCMs are chosen and scored by a certified speech-language pathologist on admission and again at discharge from SLP services to evaluate the amount of change in communication and/or swallowing abilities after speech and language intervention and submitted to ASHA's national registry. In addition to scoring the FCMs, SLPs also provide basic information on patient/client demographics and intervention characteristics (e.g., SLP diagnosis, frequency/intensity of treatment). To measure dysphagia, there are measurements termed “Swallowing Functional Communication Measures” which are ranged in a number of levels. A description of the subset levels for Swallowing Functional Communication Measures are as follows:

LEVEL 1: Individual is not able to swallow anything safely by mouth. All nutrition and hydration is received through non-oral means. (PEG etc.)

LEVEL 2: Individual is not able to swallow safely by mouth for nutrition and hydration but may take some consistencies with continuous maximum cues in therapy only. Alternate method of feeding required.

LEVEL 3: Alternative method of feeding required as individual takes less than 50% of nutrition and hydration by mouth, and/or swallowing is safe with consistent use of moderate cues to use compensatory strategies and/or requires maximum diet restriction.

LEVEL 4: Swallowing is safe, but usually requires moderate cues to use compensatory strategies, and/or the individual has moderate diet restrictions and/or still requires tube feeding and/or oral supplements.

LEVEL 5: Swallowing is safe with minimal diet restriction and/or occasionally requires minimal cueing to use compensatory strategies. The individual may occasionally self-cue. All nutrition and hydration needs are met by mouth at mealtime.

LEVEL 6: Swallowing is safe, and the individual eats and drinks independently and may rarely require minimal cueing. The individual usually self-cues when difficulty occurs. May need to avoid specific food items (e.g., popcorn and nuts), or require additional time (due to dysphagia).

LEVEL 7: The individual's ability to eat independently is not limited by swallow function. Swallowing would be safe and efficient for all consistencies. Compensatory strategies are effectively used when needed. (ASHA. (2003). National Outcomes Measurement System (NOMS): Adult Speech-Language)

Swallowing-related dietary levels/restrictions include the following:
(a) Maximum restrictions: Diet is two or more levels below a regular diet status in solid and liquid consistency.
(b) Moderate restrictions: Diet is two or more levels below a regular diet status in either solid or liquid consistency (but not both) OR diet is one level below in both solid and liquid consistency.
(c) Minimum restrictions: Diet is one level below a regular diet status in solid or liquid consistency.

Specifically for solids, the different levels would include the following:
(1) Regular: No restrictions.
(2) Reduced one level: Meats are cooked until soft, with no tough or stringy foods. Might include meats like meat loaf, baked fish, and soft chicken. Vegetables are cooked soft.
(3) Reduced two levels: Meats are chopped or ground. Vegetables are of one consistency (e.g., souffle, baked potato) or are mashed with a fork.
(4) Reduced three levels: Meats and vegetables are pureed.

The National Dysphagia Diet (NDD) was developed through consensus by a panel of dietitians, SLPs, and a food scientist. It proposes the classification of foods according to eight textural properties, and anchor foods to represent points along continua for each property. A hierarchy of diet levels is then proposed, with inclusion and exclusion of items at each level based on subjective comparison with these anchor foods. There are four levels of semisolid/solid foods were proposed in the NDD:
NDD Level 1: Dysphagia-Pureed (homogenous, very cohesive, pudding-like, requiring very little chewing ability).
NDD Level 2: Dysphagia-Mechanical Altered (cohesive, moist, semisolid foods, requiring some chewing).
NDD Level 3: Dysphagia-Advanced (soft foods that require more chewing ability).
NDD Level 4: Regular (all foods allowed).

### Nutritional Snack Prior Art

The prior art of nutritional snacks in the lay art is extensive and well-known to those skilled in the art of cooking and baking. Certain snacks, such as cookies, crackers, etc. are considered “junk food,” but in fact do have nutritional content.

In the patent literature, improvements in the formulation of nutritional snacks has described and published. For example, U.S. U.S. Pat. No. 3,849,542 to Blagdon et al. describes a fortified snack process and product to overcome the problem of high fat content. Likewise, U.S. Pat. No. 4,565,701 to Ferguson et al. describes a nutritional composition designed for weight control. Further, U.S. U.S. Pat. No. 6,716,462 to Prosise et al. describes a formulation for a nutritionally-balanced snack food.

Some of the patent prior art for nutritional snacks that specifically addresses the problems with dysphagia is described in U.S. U.S. Pat. No. 6,592,863 to Fuchs et. al. Likewise, U.S. Pat. No. 8,623,323 to Holahan describes a beverage thickening agent for dysphagia.

But there is a continued need for developing a nutritional snack wafer that is specially formulated for dysphagia after taking into consideration of all the different levels of dietary requirements for dysphagia patients.

### SUMMARY

The present inventive subject matter is a wafer with a high calorie density to be used as a nutritional supplement that will help increase daily caloric intake for weight gain and provide diet texture modification in conjunction with dysphagia management.

Further, the present inventive subject matter will commonly be provided in wafer form and serve as a 200-calorie oral supplement for individuals who require therapeutic nutrition for the management of their health.

These and other embodiments are described in more detail in the following detailed descriptions and the figures. The foregoing is not intended to be an exhaustive list of embodiments and features of the present inventive subject matter. Persons skilled in the art are capable of appreciating other embodiments and features from the following detailed description in conjunction with the drawings.

### BRIEF DESCRIPTION OF THE DRAWINGS

FIG. 1 shows a partially cut-away view of a snack wafer according to an embodiment of the invention.

FIG. 2 is a flowchart for making a snack wafer according to an embodiment of the invention.

FIG. 3 is a flowchart for using a snack wafer according to an embodiment of the invention in a dysphagia patient evaluation.

### DETAILED DESCRIPTION

Embodiments of the invention are nutritional snack wafers having a substantial caloric content and a structure and composition that makes them easier and safer to consume for a patient suffering from dysphagia-related symptoms. The inventive snack wafers may be prescribed as part of a dysphagia treatment regimen.

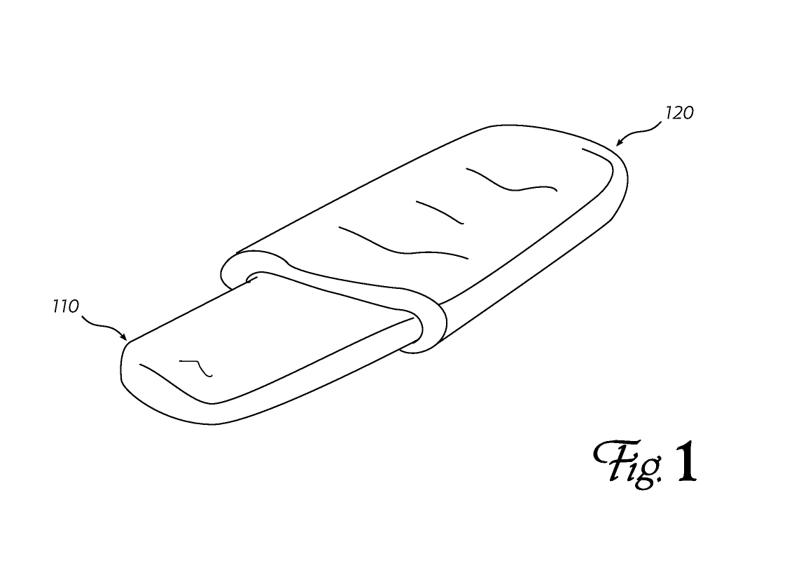

Now referring to FIG. 1, an exemplary nutritional snack wafer is illustrated. An individual snack wafer may be about 5″ long, 1″ wide, and 0.3125″ thick, with a weight of about 10 grams. One serving may comprise 3-5 individual wafers. It should be appreciated by those of ordinary skill that these dimensions are exemplary only. Wafers with other suitable dimensions and packaging arrangements may be made and used that generally fall within the spirit and scope of the present disclosure. One serving will preferably provide about zoo kCal.

Each wafer comprises a crisp, highly-soluble structural core 110, completely coated or enrobed in a high-calorie substance such as chocolate or a chocolate-based compound. The core may be made of meringue, dehydrated yogurt, or another similar substance. It is important that the core dissolve or decompose quickly upon exposure to saliva, water or other liquids without becoming thick, chewy or viscous. The core supports the high-calorie coating until the patient takes a bite of the wafer, then dissolves or decomposes, causing the coating to collapse for want of support. This collapse helps begin the process of converting the portion of the wafer into a swallowable consistency.

The chocolate coating is preferably fairly low in moisture content, and furthermore somewhat resistant to moisture and vapor transmission, so that the structural core better resists becoming stale or soggy. Each serving of these nutritional wafers (which typically comprises three to five wafers) may be packaged together in a moisture-resistant pack, such as a cellophane or mylar wrapper.

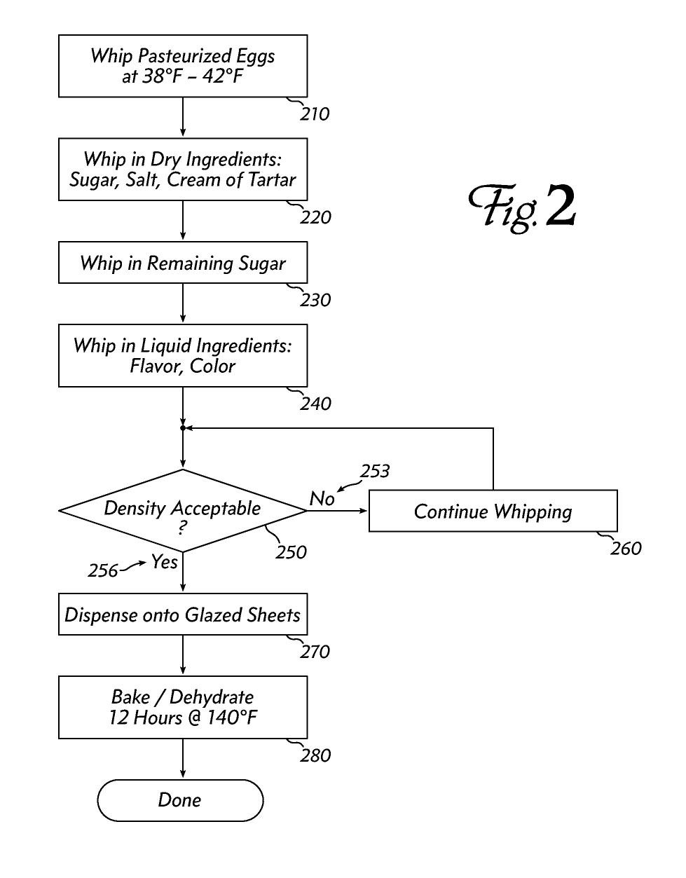

Nutritional wafers according to an embodiment of the invention may be made in a variety of flavors. The structural core may be a meringue comprising granulated sugar, egg whites, cream of tartar and salt, with a flavoring such as alkali-processed cocoa, vanilla, lemon oil or strawberry oil. Beta carotene, beet juice or paprika may be added for coloration. FIG. 2 outlines a process for producing wafer cores.

First, pasteurized egg whites, preferably between 38° F. and 42° F., are whipped for 10 minutes (210). Next, cream of tartar, salt and a first portion of the fine granulated sugar are gradually added over about 10 minutes, while continuing to whip the mixture (220). Then, the remainder of the fine granulated sugar is added over about 8 minutes (whipping continues) (230). Last, liquid flavors (e.g., vanilla, lemon oil, strawberry oil) are added while whipping (240). In some embodiments, flavor or consistency modifiers such as licorice, slippery elm or wild yam may be added to the meringue batter during mixing.

It is appreciated that some flavoring additives may be effective to promote saliva production, leading to better mastication and swallowing success and improved patient outcomes. Sour flavors such as lemon, lime or orange, pair well with certain coating flavors. Bitter flavors such as coffee or unsweetened chocolate may be preferred by some patients. Tart flavors—similar to sour, but with further astringency—are also contemplated.

A sample of the batter is checked for proper density (250). In some processes, batter density between 840 and 880 grams per 2.268¹ liters is preferred. If the proper density has not been achieved (253), whipping continues (260). When the desired density is reached (256), the batter is dispensed (e.g. via a Multi-Drop machine) onto glazed baking sheets (270). These are loaded into a low-temperature oven or dehydrator and baked (280) to produce finished wafer cores. The baking process is closer to drying than conventional baking: in some embodiments, the processing time may be about 12 hours at 140° F. A useful process parameter is the batter's total moisture loss in the dehydrator. A moisture loss of 30%±5% produces adequate wafer cores. ¹ The odd volume of this container is due to its sizing relative to a U.S. weight measure: a container that holds 5 pounds of water is 2.268 liters in volume.

An alternative wafer core may be manufactured by dispensing a flavored yogurt-based batter onto baking sheets and subjecting it to a freeze-drying process. The resulting wafers have a similar density to the baked/dehydrated meringues, and adequate solubility in saliva/liquids to perform as required by an embodiment.

The baked or dried wafers produced by a previous process are then coated or “enrobed” in a high-calorie coating such as a chocolate compound or a flavored Greek yogurt compound. This coating is applied warm and then cooled to set on finished wafers. These are packaged into airtight wrappers, such as cellophane or mylar wrappers. A package may contain a single wafer, or a plurality of wafers comprising a single service (which is preferably about zoo kCal). The airtight wrapper is the primary means of preventing product degradation via moisture uptake and volatiles evaporation, but the high-calorie coating also provides a measure of protection for the structural core from air and water vapor.

When a high-calorie wafer manufactured as described above is unwrapped and a piece is bitten off, the bolus begins as a solid. However, once the structural core is exposed to saliva, it will break down and dissolve within a few seconds, even with minimal mastication. As the bolus is propelled from the oral/lingual cavity to the posterior pharyngeal wall, the dissolved core and now-unsupported coating will become a paste. The product is intended for patients on a general and/or mechanical soft diet, however; may be tolerated by some patients who are on a pureed diet.

Because the product dissolves into a paste-like consistency, it may be appropriate for those patients who are unable to tolerate any other solid bolus safely. The small “bite size” wafers would be suitable for the cognitively impaired patient who shows a preference towards finger foods.

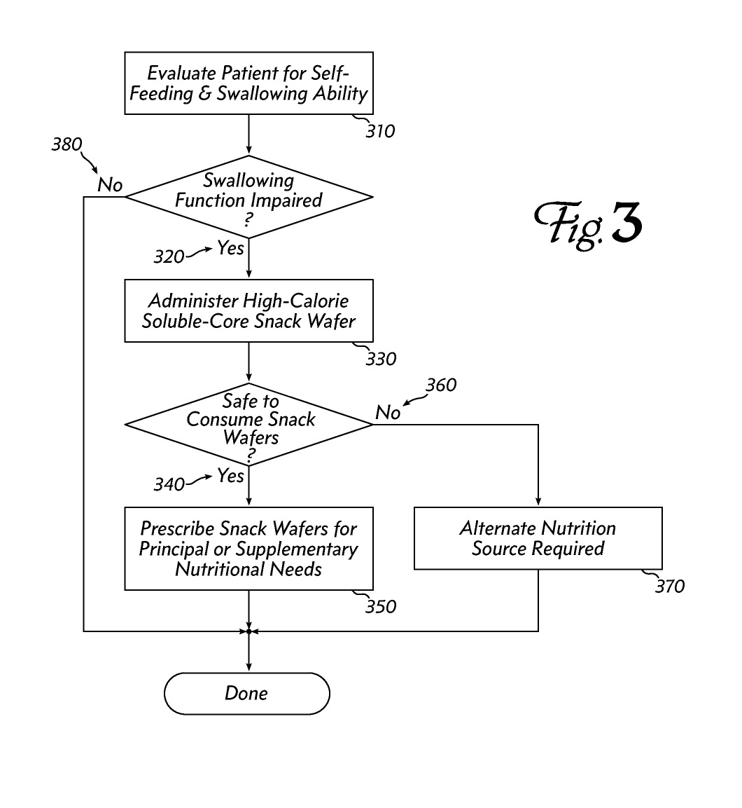

The wafer can also be used for clinical evaluation of swallowing either at the bedside, during fiber optic evaluations of swallowing or during video fluoroscopic swallowing evaluations. For example, as outlined in FIG. 3, a patient who presents with dysphagia-like symptoms may be evaluated for self-feeding and swallowing ability. When assessing a patient's swallowing, the clinician takes into account results of the oral motor examination and the patient's overall health. There are many situations when a clinician may be reluctant to try a solid bolus due to the patient's increase risk of choking. Reduced lingual/mandibular/labial strength, reduced oral coordination, changes in breathing and generalized weakness are just a few characteristics that would alert a clinician to be apprehensive about trialing a solid bolus. The inventive wafer provides a new diagnostic tool for many clinicians who are concerned about giving their patients a solid bolus due to risk of choking. Because the wafer begins as a solid, it allows the clinician to assess swallowing function of similar textures, however, because the wafer quickly melts into a paste it may present less of a choking risk for some patients.

In accordance with the foregoing concerns, a clinician assesses the patient's self-feeding and swallowing ability (310). If the patient's swallowing function is impaired (320), a practitioner may administer a high-calorie, soluble-core snack wafer as described above (330). If the patient can safely consume the product (340), the practitioner may recommend the use of these wafers to supply the patient's primary or supplementary nutritional needs (350). If the patient cannot safely consume the product (360) (e.g., due to xerostomia or lack of swallowing reflexes or coordination), then alternate nutrition sources must be investigated (370). If, upon evaluation, the patient's swallowing function is not significantly impaired (380), then the product would not be indicated (but a patient may enjoy the snack wafers anyway). In some instances, a wafer according to an embodiment of the invention may be paired with barium sulfate for use during oral-pharyngeal radiographic evaluations.

The many aspects and benefits of the invention are apparent from the detailed description, and thus, it is intended for the following claims to cover all such aspects and benefits of the invention which fall within the scope and spirit of the invention. In addition, because numerous modifications and variations will be apparent and readily occur to those skilled in the art, the claims should not be construed to limit the invention to the exact construction and operation illustrated and described herein. Accordingly, all suitable modifications and equivalents should be understood to fall within the scope of the invention as claimed herein.

I claim:

1. A calorie-dense food with improved ease of consumption by dysphagia sufferers, comprising:
a crisp, highly-soluble structural core; and
a calorie-dense coating surrounding the structural core, wherein
the calorie-dense coating retards liquid and vapor ingress into the structural core.

2. The calorie-dense food of claim 1 wherein the structural core consists of meringue.

3. The calorie-dense food of claim 1 wherein the structural core consists of yogurt.

4. The calorie-dense food of claim 1 wherein the structural core is baked.

5. The calorie-dense food of claim 1 wherein the structural core is freeze-dried.

6. The calorie-dense food of claim 1 wherein the structural core is dehydrated at a temperature between about 90° F. and about 180° F.

7. The calorie-dense food of claim 6 wherein the temperature is about 140° F.

8. The calorie-dense food of claim 1 wherein the structural core is flavored with a tart substance.

9. The calorie-dense food of claim 1 wherein the structural core is flavored with a sour substance.

10. The calorie-dense food of claim 1 wherein the structural core is flavored with a bitter substance.

11. The calorie-dense food of claim 1 wherein the calorie-dense coating comprises chocolate.

12. The calorie-dense food of claim 1 wherein the calorie-dense coating consists of chocolate.

13. The calorie-dense food of claim 1 wherein the calorie-dense coating is a Greek yogurt-based coating.

14. A method comprising:
evaluating a patient for self-feeding and swallowing capacity;
if the patient has impaired swallowing function, providing a nutritional snack wafer to the patient, said nutritional snack wafer consisting essentially of a crisp, soluble structural core enrobed in a high-calorie coating; and
observing the patient consuming the nutritional snack wafer to assess whether the patient may safely self-feed using the nutritional snack wafer.

15. The method of claim 13, further comprising:
directing the patient to use nutritional snack wafers consisting essentially of a crisp, soluble structural core enrobed in a high-calorie coating when experiencing symptoms of dysphagia.

16. A calorie-dense snack wafer for dysphagia sufferers, consisting essentially of:
a structural core formed of lemon-flavored meringue, the structural core enrobed in a chocolate coating.

17. The calorie-dense snack wafer of claim 15 having a length of about 5″, a width of about 1″, and a thickness of about 0.3125″.

18. The calorie-dense snack wafer of claim 15 having a caloric content of about 70 kCal.

19. The calorie-dense snack wafer of claim 15 packaged in a group of three to five wafers in a substantially airtight wrapper, said group having a total caloric content of about 200 kCal.
